(19) United States
(12) Patent Application Publication
(10) Pub. No.: US 2011/0078779 A1
(43) Pub. Date: Mar. 31, 2011

(54) Anonymous Preservation of a Relationship and Its Application in Account System Management

(76) Inventors: Song Liu, Saint Louis, MO (US); Min Guo, Saint Louis, MO (US)

(21) Appl. No.: 12/567,066

(22) Filed: Sep. 25, 2009

(51) Int. Cl. H04L 29/06; G06F 17/30

(52) U.S. Cl. 726/9; 726/28

(57) ABSTRACT

Disclosed is a system or method of using hash functions to preserve a relationship. A relationship is anonymously preserved by storing the hash result of a relationship token that comprises a finite set of values of a plurality of objects. Specifically, an account anonymous identifier of an account can be produced by hashing a relationship token that comprises identity information of an owner of said account. A party that has enough knowledge of an account owner can independently produces said account anonymous identifier and therefore, securely communicates with a specific account without prior communication or a password. An account owner can further prove his/her ownership of an account by submitting related documents and a relationship token that comprises his/her identity information to an account system.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The present invention relates to information security technology. More precisely, this invention uses hash functions to preserve a relationship anonymously without preserving the original values that define said relationship.

2. Description of Related Art

Since the popularity of personal computers and internet increases, more and more information is stored and processed in digital format. While such changes bring us great benefit of modern life, privacy protection is becoming a bigger concern everyday.

A typical example is the Personal Health Record (PHR) program promoted by the U.S. government. This program is supposed to be accessible online by the year 2014 and by then everyone should have a complete, accurate medical history summary.

Unfortunately, the participation for the PHR program is very slow due to privacy concerns. Most people do not want the government, the health insurance companies, the employers or the irrelevant individuals to know too much about their medical history. Without the active participation from individuals, it is not possible to keep their records up to date. Any PHR program that is solely updated by a government or medical institutions would then be obsolete quickly.

A popular solution for promoting personal participation is to set up a PHR website, allowing people to login to his/her account and to do data updates and access control. However, many relevant websites still store unnecessary personal information, leaving personal identity information in danger. Any party that is able to access the website database would be able to access personal identity information without permissions.

Reversible data encryption can protect data by using encryption/decryption keys. Without knowing the decryption key, an agent would have great difficulty to get meaningful information from the encrypted data. However, data encryption brings in three new problems: first, securing and recovering the keys are difficult; second, keys are needed for a data read or update; third, the government or company will not be able to generally analysis the stored data and get statistic medical results if each user uses his/her private encryption keys,

An anonymous account system for a PHR website can solve the privacy problem from a different path. Since personal information is never stored within an anonymous account database, it would be much less harmful if a record was stolen. An anonymous account system can safely leave most health data in plain text format, preserving the analysis and statistics potential for public health information databases.

However, two existing problems prevent a prior art anonymous account system from being widely used. First, an anonymous account lacks some distinguished features or relationships that a third party can use to identify the anonymous account. In other word, it is very difficult for a third party to automatically exchange data with an anonymous account. Obviously, a PHR website is not very useful if a third party, like a hospital or a clinic, cannot automatically upload its medical records to a PHR account. Second, it is very difficult to recover an anonymous account if the user happens to lose his/her login name or password. By definition, an anonymous account database should not store personal information. Without such information, an account system cannot effectively verify the identity of a client and cannot recover the account ownership practically for a regular user.

Accordingly, what is needed is a system and method for a party to identify an account independently based on its legitimate knowledge of the owner of said account. Moreover, what is needed is a system and method for an account owner to acclaim his/her account ownership based on verifiable legitimate identity information.

### SUMMARY OF THE INVENTION

Certain one-way hash function's injective feature and one-way feature are used to preserve a relationship anonymously. The injective feature ensures a one-to-one relationship. The One-way feature ensures it is not computationally possible to generally reverse a hash result back to its original form.

This invention provides a method of using one-way hash functions to anonymously preserve a relationship. It also demonstrates how to verify whether said preserved relationship exists among a given set of values. In one exemplary embodiment, a visibility problem of password duplication is solved by preserving a relationship between a login name and a password. In the other exemplary embodiment, account identification and account recovery problems are solved.

In one aspect of said account identification and recovery solution, an account owner must preserve at least one unique relationship for account identification purpose. A unique relationship can be defined and preserved by a relationship token. Certain relationships among an account owner's identity information are good candidates for account identification. For example, a relationship between a Social Security Number (SSN) and a birth date, a relationship among a name, a driver license number and a phone number are good candidates. For account recovery purposes, the information used should be verifiable by identity documents. Then, the relationship token is hashed to produce an encrypted value called an account anonymous identifier. Finally, this identifier is preserved and registered within an account system for account identification purposes.

In another aspect, a third party that needs to exchange data with an account system has to have enough identity information for account owners. The third party uses its own identity data to construct a relationship token that defines a registered or preserved relationship. The third party submits the hash result of said relationship token as an account anonymous identifier together with the data that needs to be exchanged to an account system. An account system will process the exchanged data for an existing account that is identified by a submitted account anonymous identifier.

In still another aspect, a third party can further prove he/she is the owner of the identified account by providing his/her relationship token and his/her identity documents to an account system. If the submitted relationship token is truly constructed with the identity information from the submitted documents and the hash result of the submitted relationship token can be used to successfully identify an existing account, the account system will be able to grant the account ownership of said existing account to this third party.

In yet another aspect, the account system can optionally improve its security level for a stored account anonymous identifier by doing an extra level of hashing. The extra hashing generates a new account anonymous identifier from an existing account anonymous identifier. An account system stores said new account anonymous identifier for account identification purposes. Any account anonymous identifiers submitted by a third party need to be hashed again before being used to compare with a preserved new account anonymous identifier.

### BRIEF DESCRIPTION OF THE SEVERAL VIEWS OF THE DRAWING

Not Applicable

### DETAILED DESCRIPTION OF THE INVENTION

A few values are considered related if they can achieve a known function by working together. An area code and a local phone number are related because an area code describes the right area and a local phone number describes the final destination within the area. By working together, they make a long distance call goes through. A social security number and a birth date for a person are related because by working together, those two values can describe said person in more detail than a social security number can do alone. Those “related” relationships are considered abstract relationships.

This invention is inspired from the idea that some kinds of relationships among a finite set of values of a plurality of objects can be preserved anonymously as a relationship identifier by hashing their relationship tokens. A relationship token is an ordered sequence of string values selected from a finite set of string values of a plurality of objects. A string is an ordered sequence of symbols. An object is a general term for an article or a thing. For instance, a person's birth date is an object. It has a value and its value can be in different formats. A birth date object has a string value of “12311962” if the date is Dec. 31, 1962 and its format is “MMDDYYYY”. Here MM is the month portion; DD is the date portion and YYYY is the year portion.

Although a relationship involves at least two values, a relationship token might appear comprising only one value. In this scenario, said one value is actually a relationship token for a more detailed relationship. For example, a ten-digit phone number, “123 456 7890”, is “one value” of a long distance phone number object. It can be directly used as a relationship token because it can be considered as comprising two other objects called an area code object with a value of “123” and a phone number object with a value of “456 7890”. It describes a relationship of an area code object value and a phone number object value. Obviously, a relationship token can comprise another relationship token or its hash result because they can be considered as values too. For the same reason, a date object value can be considered as one value, or be considered as a (relationship token) permutation of three object values of year object value, month object value and the day of month object value.

A relationship can be stored or preserved by saving a relationship token into a data storage media like a database. A relationship can be anonymously stored or preserved by saving the hash result of a relationship token into a data storage media like a database. A hashing process can preserve a relationship anonymously because its injective result is irreversible. Its injective feature ensures it is information preserving; its irreversible feature ensures the original source is safe; its random like hashing result make its preserved relationship anonymous. The hash result of a relationship token is a relationship identifier. Depending on how a hash process is designed and how a relationship token is constructed, a relationship identifier can be a single hash value or a permutation of hash values. Storing a relationship identifier is preferred due to its anonymous feature.

A preserved relationship can be used to verify whether same relationship exists among a finite set of given values. The first verification step is to construct a test relationship token comprising said finite set of given values. The construction should be done the same way as the construction of a relationship token which hash result has been preserved as a relationship identifier. The second verification step is to hash said test relationship token the same way as said relationship token was hashed. The last step is to compare the hash result of said test relationship token with stored relationship identifiers for a match. A preserved relationship is confirmed among said finite set of given values if a match is found.

Because a relationship is an abstract concept, a preserved relationship is suitable to conceal the details of the values that define a relationship. Since a relationship involves at least two parties, a preserved relationship could be more sophisticated than any single value involved in said relationship. This sophistication feature makes a preserved relationship identifier a better choice as an identifier that needs to be unique.

An account system generally refers to a system that supports various activities of an account. An UNIX account system, for example, refers to hardware to run UNIX operating system software, store files and certain utility software to manage a user account and its activities. A typical UNIX account user uses an internal network to communicate with an UNIX account system. A website account system will have a web server to communicate with different clients on the other side of internet. The web server typically provides multiple web pages for a client to register a new account, login to an existing account and do daily account management activities. Physically, a web server can be anywhere in the world. As long as the web server can be accessed by an internet user, it is considered as a part of an account system. Because a website account system might need to serve a large number of users, a database is usually included in a website account system.

A hashing process is a key operation in this invention. Its core operation uses a special kind of hash function called a one-way hash function. A one-way hash function takes an arbitrary block of data and returns a fixed-size string. The one-way hash means that it's nearly impossible to derive the original string from its hash result. Defining mathematically, a one-way hash function H operates on an arbitrary length input message M, returning h=H(M). The important properties are:

Given M, easy to compute h=H(M)
Given h, hard to compute M such that h=H(M)—“one-way”
Given M, hard to find M′ (different from M) such that H(M)=H(M′)
Hard to find M,M′ such that H(M)=H(M′)—“collision resistant”

Theoretically, a hash function cannot be injective because its input value space is unlimited and its result value space is limited. However, the limited value space (like 128 bits or 512 bits) is so huge that it is virtually unlimited for most business needs. Therefore, many hash functions can be safely considered as having injective feature.

Popular hash functions that satisfy the mentioned requirements include MD5 (Message Digest Algorithm 5) and SHA (Secure Hash Algorithm) functions. MD5 converts an arbitrary length input message to a fixed string of 128 bits. SHA functions convert an arbitrary length input message to a fixed string of 160 to 512 bits, depending on which SHA implementation algorithm is used. So far, there is no known collision case for SHA 256/224 bits or any longer bits of the SHA versions. Therefore, SHA256 is a good option for large account systems. A lot of free source codes for MD5 and SHA implementation can be found from the internet.

There are many ways of using a one-way hash function in this invention. A complicated hash process may use multiple hash functions, take multiple inputs and then produce a permutation hash result. A relationship token may also be divided to a few portions so that each portion is one input for a complicated hash process. A simple hash process may use only one well known hash function; take one input and produce one string value hash result. Since a hash process usage must be consistent among multiple parties, a simple hash process is usually preferred. For example: a web server can use a JavaScript implementation for a well known hash function as a hash process. As a client accesses a web page that needs to do one-way hashing, the JavaScript is sent to the client side (machine) along with the accessed web page. Then the JavaScript finishes the hash work at the client side. A client can avoid certain espionage by doing hash work on the client side and sending only the hash result back to the server.

Another way of using hash functions is to allow a client to choose a hash function implementation from a trusted third party and let that function do the hash work. For those users who have trusty network or use secure network protocols, like Https, the hash work can be done within an account system as well.

As the computational power is rapidly increasing, MD5 or SHA hash function will eventually become vulnerable and obsolete. As long as newly proposed one-way hash functions satisfy the conditions mentioned earlier, the method described by this invention will still work.

### Exemplary Embodiment 1

### Solving a Visibility Problem of Password Duplication

In this exemplary embodiment, a visibility problem of password duplication is solved by preserving a relationship between a login name and a password. Because people tend to use memorable strings as their passwords, a lot of duplicated passwords could be found in large account systems. Detectable password duplication is undesirable since it compromises the strength of password protections.

A convention account system stores a login name and a password for each account that needs access control. The password is stored either in its original form or in an encryption form. Either way, the duplicated passwords are detectable by doing a search for stored passwords or their encryptions. With the help from stored relationships of login-password pairs, password duplication phenomena can be concealed for better password protection purpose.

Conceptually, a login name is a string value of a login name object; a password is a string value of a password object. A token that comprises a login name and a password (called login password token) can represent a unique relationship of said login name and said password. Since a relationship token is defined as an ordered sequence of string values, there are many ways to implement a relationship token in a programming language. A string with each value appended together and an array are two common ways of relationship token representations. In this example, an appended string is used to represent a relationship token because its data structure is simple and can be implemented independently by multiple parties without confusion.

Generally speaking, if a finite set of values contains at least one unique value, an appended string that comprises said finite set of values and a way of separating adjacent values is always unique. Here the requirement of “a way of separating adjacent values” is necessary to prevent a “relationship coalescence” phenomenon in a string appending operation. A relationship coalescence phenomenon is defined as a relationship token losing a relationship due to an improper relationship token operation. For example: login name [A] having a password of [BC] is a relationship; login name [AB] having a password of [C] is another relationship. Without a way of separation for the login part and the password part, both login-password pairs could be appended as [ABC]. This result “coalesces” both relationships into a new relationship that is rooted from the common features of both said relationships. This is undesirable and should be avoided.

There are many ways of separating values in an appended string representation of a relationship token. One way is to put one or more special characters between different values as a value separator. For example, a bar [|] can be used as a separator to get a unique appended string representation like [A|BC] and [AB|C] for prior examples. Another way is to define a fixed length for each value portion and padding any value that is shorter than a defined length. In other words, a value has to be formatted to a fixed length string before being used to construct said relationship token. Theoretically, an appended string that has n value portions needs no more than n−1 portions to have defined lengths, where n is an integer starting from 1.

Certain hash functions can be used to hash the values used by a relationship token and get their injective equivalents in a fixed-length-string format. Those injective equivalents can replace the original values to construct a relationship token and avoid a relationship coalescence phenomenon. In other words, a value has to be hashed to a new string value before being used to construct said relationship token. Of course, the newly constructed relationship token will represent a mapped relationship, not the original relationship that exists among the original values.

For the purpose of avoiding a relationship coalescence phenomenon, the requirement of producing a fixed length result for a certain hash function can be relaxed. An encryption function that can output a near random encryption result is good enough to solve a relationship coalescence phenomenon. The reason is that a string consisting of two random-like encryptions is virtually impossible to be the same as another string that consists of another two random-like encryptions if each encryption is sophisticated enough. Therefore, in a relationship token construction, encrypting the values that define a relationship and using the obtained encryptions values to replace the original values in constructing said relationship token will solve a relationship coalescence problem. This method can be further simplified with the fact that a random-like encryption value can serve as a value separator if it is sophisticated enough. Said encryption is a value separator because its randomness ensures that it cannot coalesce with its adjacent values. Therefore, to solve a relationship coalescence problem for an appended string representation, only every other value in said appended string needs to be encrypted.

Another way of separating adjacent values of an appended string representation of a relationship token is to let adjacent values use different symbol sets. For example, a symbol set of digits (0-9) can work perfectly with a symbol set of the English alphabet (a-z and A-Z). A social security number and a regular family name constructed as “123456789smith” is a specific example for using different symbol sets, assuming no regular last name contains a numerical digit (0-9).

By using one of the mentioned ways to separate a login name and a password, we are able to construct a unique relationship token comprising a login name and its password by a way of appending. Then said unique relationship token is hashed to generate a relationship identifier. A hash process used in this operation can be as simple as one hash function. The relationship identifier is stored and preserved in a database. The storage of said relationship identifier preserves a unique relationship between said login name and its password. When a password needs to be verified, an account system can use this password and its login name to construct a test relationship token in the same way as a said unique relationship token was constructed. Then this test relationship token is hashed to produce a test relationship identifier using the same hash process. Then the test relationship identifier is used to compare with the stored relationship identifiers until a match is found. A password is positively verified if a match is found. Since each relationship identifier is unique, the password duplication phenomena are concealed in an account system.

Because the relationship of a login name and its password has been implicitly preserved in a stored anonymous password identifier, an association of a login name and its password does not need to be specifically stored for the purpose of a password validation. A general search for a table containing a column that stores said anonymous password identifiers will be able to verify a given password. The table column that stores anonymous password identifiers can be used to store login names or their encryptions as well.

### Exemplary Embodiment 2

### Account Identification and Recovery

In this exemplary embodiment, an account identification and recovery method is fully described, including: 1. An Account Anonymous Identifier Registration 2. Remodeling an Existing Account System 3. Account Identification 4. Account Recovery. For the sake of brevity, conventional account system development and other functional aspects of an account system will not be described in detail herein. Furthermore, examples are presented in a way that an experienced web application developer can easily implement this invention into his/her work.

### 1. An Account Anonymous Identifier Registration

In order to achieve the account identification and recovery functions discussed in this invention, an account user needs to choose at least one relationship token and register its hash result as an account anonymous identifier for his/her account. Theoretically, an ordered sequence of string values can be used as a relationship token. In reality, a relationship token should be constructed in a simple way that has least implementation confusion. The simplicity is needed because said token will be constructed by multiple parties. In this example, an appended string representation of a relationship token is used for illustration purposes. A relationship token is equivalent to an appended string in this embodiment. The token should be constructed by choosing right identity objects' values so that the following conditions can be satisfied.

a. The selected relationship token must be unique within said account system. Because a chosen one-way hash function preserves the one-to-one relationship between the relationship token and its hash result (an account anonymous identifier), such uniqueness requirement can ensure the account anonymous identifier will be unique within an account system. This assumption is valid in reality. However, due to the fact that the input of a hash function is unlimited and the output is a limited length string, a collision will eventually happen. Therefore, a better requirement for the account identifier uniqueness is that “said account anonymous identifier is unique within said account system”. The uniqueness requirement can be achieved by searching existing registered account anonymous identifiers for any collisions.
b. The relationship token must be constructed with the objects' values that contain verifiable identity information of an account owner, such as a social security number plus a name or a birth date, a driver license number plus a zip code of the account owner. This rule gives an account owner an exclusive right to own and prove his/her ownership of said relationship token. If a client can provide a relationship token and prove this token can be constructed with his/her unique identity information, the account system has a strong reason to believe that the account related with the hash result (an account anonymous identifier) of this token belongs to this client. To avoid frequent updates for an obsolete account anonymous identifier due to identity information change, a relationship token should be constructed with relatively steady identity information.
c. Within the requirement of using verifiable information to construct a relationship token, a user or a client should not choose an object's value that is uncommon to construct his/her relationship token. The reason is that this token will need to be constructed by other parties that need to exchange data with the account system. If the other parties are not able to construct the same relationship token due to lack of uncommon personal information, the other parties would not be able to provide a correct account anonymous identifier and, would not be able to exchange data with an account system automatically.

Before a convention for constructing a relationship token is to be adopted, it is a good idea for a third party that needs to exchange data with an account system to construct a few different relationship tokens, possibly in a different format like an array format or a string format, and submit their hash results as account anonymous identifiers. Such operation can increase the chances that an account system will find an account match. For the same reason, an account owner can construct a few different relationship tokens and register their hash results as multiple account anonymous identifiers. Obviously, if an account owner chooses to use a relationship token constructed by the identity information of a different person, like a spouse of the owner, this account will be able to exchange data belonging to said spouse as well. Further more, an account owner can let the said spouse to access said account. Such flexibility about account anonymous identifiers laid a foundation for an account sharing.

If an account does not need to exchange data between an account system and a third party, a relationship token can be constructed with uncommon identity information. Furthermore, if the account does not need to have a supported account recovery feature, a relationship token does not need to be constructed with verifiable identity information. A good example is a prepaid cell phone account management: the phone company can protect the phone usage privacy by concealing the phone numbers. An anonymous account can use a phone number as a relationship token and its hash result as an account anonymous identifier. Since any activity of this phone number can be tracked by said account anonymous identifier, the phone number will not need to be stored in an account system. Such implementation safely hides a phone number from its user activity. Needless to say, such implementation can be used in other industries or research fields when data identity serves as an identifier and also needs to be concealed.

A chosen relationship token should also be reasonably sophisticated. For example: a social security number is considered an ideal token candidate for meeting the uniqueness requirement, but it alone is not sophisticated enough to be a good relationship token. A hacker can save the possible social security numbers, about one billion numbers in total, and their hash results into a database table. A simply hash value look up will be able to reverse a related social security number. Therefore, a social security number must be combined with other personal data to form a more sophisticated relationship so that no database can handle all the possible values easily. Given the current computational power, a social security number plus a birth date is a good relationship token candidate. By appending a birth date at the end of a SSN, the new token will have about 36,500 times more values than using a social security number alone. 36,500 is the number of days for one hundred years. The sophistication of a relationship token can be rapidly increased by adding more personal information to a relationship token if needed.

Since appending is used to construct a relationship token in this embodiment, a “relationship coalescence” phenomenon must be avoided. This phenomenon has been fully discussed in the other embodiment. Among many ways of string separations that have been discussed in the other embodiment, using a hash process to pre treat a value for a relationship token might not be a good option. The encryption makes it more difficult to verify if said relationship token is constructed with certain identity information. Fortunately, identity information usually has a fixed length or uses a unique symbol set and can be directly appended with each other without relationship coalescence problems.

Finally, a relationship token needs to be hashed so that an account anonymous identifier can be obtained. Generally speaking, the hash process used should be consistent among an account owner or a client, a third party that needs to exchange data with an account system and said account system. Therefore, a simple, well known hash process is preferred. Such a process can be as simple as using one well known hash function like SHA256, taking one input and generating one hash value as a hash result. A relationship token constructed by appending relevant values will produce one string. This string can be used as the only input for a simple hash process that use only one hash function to get one hash value as a hash result. This hash result is an account anonymous identifier.

Although a simple, well known hash process is preferred, it is possible for an account system to publish certain complex hash process to promote security or other business needs. A complex hash process might take multiple inputs to accommodate each value from a value set of a relationship; use multiple hash functions and/or hash multiple times; generate a hash result that has one or more hash values as an account anonymous identifier.

Whether a relationship token is hashed on a client side or on an account system server side, the generated account anonymous identifier must be the same. However, hashing a relationship token on a client side and submitting the generated account anonymous identifier to an account system can avoid possible espionage during data transmission. A relationship token can also be submitted to an account system and allow said account system to generate an account anonymous identifier if the data transmission is secure. Typically, a secured data transmission involves a reversible encryption process.

After getting an account anonymous identifier, an account system needs to store and save said account anonymous identifier and its association with an account in a storage media so that the relationship preserved in an account anonymous identifier can be retrieved. This is called account anonymous identifier registration. Account identification, ownership recovery and verification operations will need to access stored account anonymous identifiers. A database is the most common storage media for preserving an account anonymous identifier and its association with an account. Typically, an account association is stored by setting up an account ID reference for each account anonymous identifier.

### 2. Remodeling an Existing Account System

Since the building process for an account system is well known, this invention only explains the differences. The examples include a web page set up for an account anonymous identifier registration, a web page set up for a new account registration, a login page set up for login name encryption and some data exchange issues.

When an account is created, an account system will assign an account ID to this newly created account as identification. This account ID must be unique within an account system. It could be a database generated integer. A database can ensure the uniqueness of an account ID by doing an automatic increment each time a new ID is needed. An entity can be associated with said account by setting up a reference to this account ID. For example, a stored account anonymous identifier can refer to said account ID as a foreign key to save its account association.

There are three basic steps to add an account anonymous identifier registration page to an existing account system.

a. Allowing a client to accesses this page only after he or she has created his/her account. Because an account anonymous identifier must be registered with an existing account, a client must create his/her account before doing the registration work. An effective method to enforce this rule is to put a “session” check at the beginning of the source code of this web page. A “session” can ensure that only a logged-in user can access this page. Here a “session” refers to a well known web session management technique. It can detect whether a user has logged in when a web page is being accessed.
b. Because this page typically only submits the hash result of a relationship token to a web server as a new account anonymous identifier, this page should have a hash process implemented. Since the web server cannot use common techniques to enforce the relationship token construction requirements, this page should let the user know the reason and requirements for constructing a relationship token. Assuming a simple hash process is used and it only has one input, this registration page should have one relationship token input field unless multiple relationship tokens are collected at once. It is possible to implement multiple input fields in this registration page for collecting each portion of a relationship token if the page hash process needs multiple inputs.
c. After the user submit the account anonymous identifier, an account system needs to check the submitted account anonymous identifier for any collision within its database. If there is no collision, the account system will register or store the account anonymous identifier and its association with the current account. Said association can be done by linking an account anonymous identifier with an account ID. Said association can be done by linking a login name or its encryption as a foreign key if a login name has been linked with an account ID. Said association can also be stored by putting an account anonymous identifier and a login name or its encryption in a same table record (same row or tuple).

In reality, the web pages for an account anonymous identifier registration and a new account registration can be independently implemented or be merged into one page. For remodeling an existing account system, keeping both pages independent is simple since the existing new account registration can be reused.

Merging two mentioned registration web pages into one MRP (Merged Registration Page) can be a preferred option in building a new account system. The MRP can serve both new account registration and new account anonymous identifier registration at same time. By using a chosen relationship token as a login name and only sending its hash result to a web server, the MRP implementation seamlessly merges a login name with a relationship token as one entity. Because a login name or a relationship token can never leave a client side machine in its original form, a user can use sensitive information in a login name or relationship token. For example, if a person wants to use his social security number (123456789) as a login name, the login name will be hashed to “25f9e794323b453885f5181f1b624d0b” before being sent to the server side. Here the hash result is calculated by a MD5 hash function.

If a user does not need extra account anonymous identifiers to increase the account matching opportunities, a separate new account anonymous identifier registration page mentioned earlier can be possibly skipped for a MRP implementation. Further more, if an account anonymous identifier will not be used or if said account anonymous identifier does not have a legitimate relationship preserved, a MRP implementation will still create an account that has a login name encryption feature achieved. In other words, a MRP implementation become a regular login name registration page that has a login name encryption feature implemented. This feature enforces login name protection and the encryption can be used as a replacement of the account ID of said account.

However, it is a good idea to offer users an option of using a new account anonymous identifier registration page. This page will give users control of which account anonymous identifiers can be used to link with his/her account. Because some account anonymous identifiers might become obsolete, new identifiers are constantly needed for certain users. For example: people may change their names through marriage or divorce. If a name was preserved in an existing account anonymous identifier, a new account anonymous identifier is needed for a user who wants to exchange records that use a new name.

If an account system allows its clients to register more than one login name and/or account anonymous identifier, it is a good idea to implement another web page in order to remove obsolete login names and/or account anonymous identifiers. Since adding or removing a login name and/or an account anonymous identifier uses common web technique, further discussions are skipped.

A MRP can be achieved by adding two features to a regular new account registration page:

a. Urge the user to follow the relationship token requirement when choosing a login name and have a hash process implemented. After getting the login name and password, a MRP needs to hash the login name and send its hash result (also called a login name encryption) with a password or its encryption to a web server.
b. After the user submit the login name encryption and password or its encryption, the account system needs to check the submitted login name encryption (also serves as an account anonymous identifier) for any collision within its database. The server will only store a unique login name encryption, a unique account anonymous identifier and their associations with the current account.

Because an account system only gets a login name encryption from a MRP, the account system cannot enforce any rules for a login name construction. If a client insists on choosing an arbitrary string as a login name, his/her account will not support the account anonymous identification and the account recovery features described in this invention.

Allowing a client to choose an arbitrary login name does have some advantages. For example, a client might want to test the account service before committing to a formal enrollment. A client might also want to have a short, memorable login name for daily operations.

For a MRP implementation, the account system only stores the hash result of a login name as a login name encryption. Therefore, a regular login page has to be changed to accommodate such implementation. Normally, the minimum change will include a hash process implemented by a web language script, like JavaScript, being attached within a regular login page. This script will hash the login name and send its encryption to the web server. Meanwhile, a login name hashing process can be displayed dynamically on a client side and give a user visual feedback while he or she is typing in a login name. Because a user might choose to use sensitive information as a login name, the login name input field should be masked like a password input field.

One side effect of a MRP implementation is that a login name or a relationship token might be too long for daily usage. A possible solution is to use the “cookie” technique in a login page. After a client inputs his/her login name in a login page, the page will hash the login name to generate a login name encryption and use the “cookie” technique to save the encryption on the client side for a certain period of time. Next time the client logins in, a login page will read the “cookie” and get the login name encryption. If the client does not input a new login name, the page will send this login name encryption by default. Since the “cookie” technique is well known, the detail implementation is skipped.

As mentioned earlier, most prior art accounts rely on an account ID to uniquely define an account. One problem for such an account ID is that people can guess another account ID based on a known account ID. For example, if “1000” is a known account ID, people have a good reason to believe that “999” or “1001” is another valid account ID. Therefore, a SQL query of “select * from A-Salary-Table where account-id=999” will be able to get information belonging to a different account.

This problem can be solved by using a login name encryption or an account anonymous identifier to replace an account ID. Since the possible value space of a login name encryption or an account anonymous identifier is virtually unlimited, the possibility of guessing a correct one is virtually zero.

Using a login name encryption or an account anonymous identifier to replace an account ID can be done by an existing account migration or by not creating an account ID when a new account is created. Since data migration technique is mature, the migration method is skipped.

For a new account creation, the account system can directly apply the encryption of first login name as an account ID and then swap the encryption with a registered account anonymous identifier if needed. For a MRP implementation, the login name encryption is an account anonymous identifier.

Based on the fact that an account could be identified by account anonymous identifiers belonging to different people, an account system can allow multiple people to share one account by saving the association of every record with its related account anonymous identifier. Said association can be saved by storing each record and its associated account anonymous identifier together in a table. Allowing each record to have a direct or indirect reference to an account anonymous identifier will do the job as well.

A record is related to an account anonymous identifier if it is loaded with said account anonymous identifier or if said record belongs to an account user who is associated with said account anonymous identifier. This association is usually done by associating the login name or its encryption of said account user with said account anonymous identifier.

An account is considered being shared by multiple people if a group of people can access the same account and retrieve their own data separately. An account owner can give account access control to a group of people by sharing a login password credential, or by registering multiple login names that belong to different users. Each registered login name should be associated with its own password when the registration is done. In a MRP implementation, each registered login name encryption is an account anonymous identifier. If a MRP implementation is not used, each login name should also have at least one registered account anonymous identifier associated with it. Either way, when a shared account user login with his/her login name, the account system will be able to use the associated account anonymous identifier to classify data records within said account and display only the data records that belongs to the current user. When a third party needs to exchange data with an account system, a shared account does not need any special treatment because the data is identified by a valid account anonymous identifier. A shared account has registered necessary account anonymous identifier for each shared member already.

A shared account should have a master account user to coordinate any issues between shared members. Allowing the user of the first login name or the first account anonymous identifier to be the master account user is a natural choice. Other login names added to this account later should have a reference set to link with this first login name or first account anonymous identifier or an account ID. A master account user can be implemented by adding one “master” attribute to a table that store an login name or its encryption or an account anonymous identifier. A user with this “master” attribute set should be given a super privilege to manage an account, including all the right of every shared user entitled for his/her data management.

To support an account inherence feature, a master account user should be able to transfer its super privilege to a different user in the same shared account by setting its “master” attribute. An account system should be able to do the same thing based on a formal request from the majority of the shared users. These formal requests can be implemented very similar to an account recovery request that will be discussed later on. For example, as long as more than 50% of the shared users can approve themselves using an account recovery method in this invention, a new master account user can be elected by those shared account voters.

So far, the described web pages represent the front end of the web server of an account system. At the back end, the account system needs to be able to exchange data with any third party that is able to provide a valid account anonymous identifier. Fortunately, the data exchange technology is common and mature. Popular methods include Web Service and XML schemas. The modification regarding to this invention is related with one or more account anonymous identifiers. Those identifiers could be stored in its own element or an attribute so that a data receiver party can easily get the identifiers to accomplish an account identification task. When an existing account has been identified by an account anonymous identifier provided by a third party, the third party data records associated with this identifier can be stored within said existing account. An account system can optionally allow each record to have a reference to its related account anonymous identifier stored. This record level account anonymous identifier reference storage is necessary for an account sharing implementation.

Since the number of third parties that need to exchange data with an account system is not very large, a possible third party registration can be done to validate potential third parties. Such a registration will make sure an account system only deals with pre registered, trusted data source.

Because an account system automatically matches the exchanged data to an account using a provided account anonymous identifier, it is necessary to provide the account owner an option of approving such data exchange results or requests. For data download operations, one solution is to set a staging attribute in a data record table. Another solution is to save the exchanged data record to a staging table first. Both solutions will need an extra web page option for the account owner to approve, reject or delete the exchanged records. For common data uploading requests, another web page option is needed for setting data access control. An account owner could set an access control level or restriction so that only a scheduled data upload is allowed. This access control can ensure said account owner that only an authorized party, like the doctor for his/her next appointment, can get data from his/her account. Since such operations are a common practice for a web application development team, further discussion is skipped.

In order to preserve the credibility of exchanged data, it is recommended that the data should not be modified by a client or an account owner. However, a client or an account owner should be given options of rejecting and deleting exchanged records.

Finally, an optional security enhancement can be done for storing an account anonymous identifier. So far, an account anonymous identifier stored in an account system is produced either by a client or by an account system using the same public known hash process. The account system can further encrypt said account anonymous identifier with a private hash process to produce a new account anonymous identifier and use this new account anonymous identifier to replace the original account anonymous identifier as a stored account anonymous identifier. The private hash process might use a different hash function; an encryption function with key or salt; the same hash function but applied a secret number of times or multiple ways combined to do the hash work. Under this enhanced implementation, any submitted account anonymous identifiers will need to be hashed by this private hash process before being compared with this stored new account anonymous identifier for account identification. An account is better protected because without knowing the private hash process, any party, including the owner of an existing account, will not be able to use its own generated account anonymous identifier to directly identify an existing account.

This security enhancement can be further improved by periodically updating the private hash function. Such an update will minimize the possible damage caused by some parties that accidentally acquire the private hash function.

### 3. Account Identification

There are two basic paths to identify an account: an account owner identifies his/her account by his/her login name and a third party identifies an account by a registered account anonymous identifier. Since the first path is a common practice, no further discussion is needed.

The second path can be heavily used by a third party that has enough personal information and needs to exchange data with an account system. In order to illustrate this process, a medical record example is used.

When a hospital, as a third party, needs to exchange data with an account system, it first uses its data to construct a relationship token for every patient based on his/her personal information on file. Because constructing a relationship token could be a common practice, the hospital typically knows the token formats accepted by an account system and therefore, is able to choose the right identity objects. In case a hospital does not know, a hospital can optionally construct a few different relationship tokens for each patient to increase account matching chances. For example, if the hospital knows an account system accepts the hash result of a pair of a social security number (SSN) and a birth date as an account anonymous identifier, but does not know the format for a birthday value, it can try three tokens like SSN+YYYYMMDD, SSN+MMDDYYYY and SSN+DDMMYYYY. Here YYYY is the year portion, MM is the month potion and DD is the day portion.

In the next step, the hospital will hash its constructed relation tokens and submit their hash results as existing account anonymous identifiers with medical records to an account system. The hash process used by the hospital should be the same process used for generating the stored/registered account anonymous identifiers. As long as the transmission network is secure, a hospital can optionally transmit a relationship token with the data and relay on an account system to generate an existing account anonymous identifier. For performance reasons, a hospital can also save the effective account anonymous identifiers for a certain period of time. Because an account anonymous identifier cannot be inverted, temperately saving an identifier on a client side will not impose extra risk.

After getting an existing account anonymous identifier, an account system will need to search for a match within its stored account anonymous identifiers using said existing account anonymous identifier. In case the account system has implemented the enhancement for storing account anonymous identifiers mentioned in the “Remodeling an Existing Account System” section, the account system will need to use its private hash process to hash said existing account anonymous identifier further and use the hash result to compare with stored account anonymous identifiers. Either way, if a match is found, the account related with the matching stored account anonymous identifier is considered the right account the hospital is looking for. At this stage, the account system can either store the data downloaded from the hospital into the matching account or, upload certain data from the matching account to the hospital if the account owner has set permissions to do so.

Because an account anonymous identifier is fairly sophisticated, it is virtually not possible for faking an effective identifier by guessing. Therefore, an account system can confidently load data into an existing account identified by an effective account anonymous identifier that is provided by a third party without using other security checking method like asking for a password.

### 4. Account Recovery

An account ownership recovery is needed when an owner forgets his/her login name or password. An account recovery process typically requires an email, a name, an address and some personalized questions and answers previously stored within an account. However, not every kind of account has such information available. For example, an anonymous account usually does not collect such information. A known resolution is to allow an account to store similar information in encrypted form using a private key. For example: the AES encryption can be used for this purpose. An account owner will need to provide his/her private key temperately to an account system so that the account system can decrypt the stored information for identity verification purposes. The account owner can choose a different private key and encrypt his/her identity information again after his/her account ownership has been granted. The limitation for this method is none but the user must remember his/her private key. This new invention, however, introduces an account recovery method that does not need a user to remember any keys.

When an account owner needs to recover his/her account ownership, the owner needs to select a few of his/her identity related objects and use their values to construct a relationship token. The owner then submits this token with certain documents to prove that the relationship token is truly constructed with his/her identity information. The token must be constructed exactly the same way as one of the tokens which hash result has been registered as an account anonymous identifier for this user. An account owner can optionally uses his/her personal information to construct more than one relationship token if he/she is not sure what information has been used to construct the original relationship token. As long as the tokens are constructed with verifiable identity information, an account system should accept those tokens for further operation. To prevent other users from stealing an account, an account system can further ask the acclaimed account owner to submit a notarized recovery application.

After receiving the submitted relationship token and its related document, an account system will verify the consistency of the token information with the submitted document. The account system will also hash the submitted token to produce an existing account anonymous identifier. This hash process is the same process used for generating the stored/registered account anonymous identifiers. Then an account system will use said existing account anonymous identifier to search for an identifier match within its stored account anonymous identifiers. If a match is found, an account associated with the matching stored account anonymous identifier is considered the right account the account owner is looking for.

As soon as a matching account is found and the submitted token has been proven to be truly constructed with the personal information from the submitted documents, the ownership of a matching account is granted to the user who submits the relationship token and his/her documents.

Granting an account ownership usually includes login name recovery or password reset or recovery. Password reset or recovery implementation is skipped because it is a common practice.

Because a MRP implementation stores the user login name in its encryption form, an account system will not be able to provide a user his/her unencrypted login name. Therefore, the MRP implementation needs to provide its users with an extra web page option to allow the user to create a new login name. Because such an operation is well known, further discussion is skipped.

The account recovery schema is based on the assumption that a registered account anonymous identifier has preserved certain verifiable personal identity relationship. If an account owner uses an arbitrary token, he/she will not be able to prove his/her ownership for his/her token. Obviously, a user can choose to register some account anonymous identifiers that preserve certain verifiable personal identity relationship and some identifiers that do not. Then the user will be able to use some relationship tokens to do an account recovery claim.

The account recovery schema can be used to elect a master account user for a shared account system. The shared users use the account recovery procedure to prove themselves and indicate their preferred candidate. Then the shared account system will be able to set the master user attribute and give this user the super privilege for account management based on the voting result. This method can be used as a supplement in case the existing master user cannot perform his/her duty.

### ADVANTAGES

Form the description above, a number of advantages of some embodiments of this invention become evident:

The most significant benefit of this invention is that it provides a feasible solution for a Personal Health Record program, a very important program for current health care reforms. By solving the anonymous account recovery problems and the data exchange automation problems, this invention makes an anonymous account system an ideal solution for a PHR website.

By concisely solving the account ownership recovery problem and the account identification problem, this invention makes it possible for many normal accounts to be converted or partially converted to anonymous accounts. Such account conversions bring minimum change to existing clients, but can attract potential clients who need better identity protection. A quasi anonymous account conversion also promotes objective data input about sensitive information, like secret health problems. Otherwise they may never be collected by a normal account.

Another benefit of this invention is that it makes it feasible for a prior art account system to support multiple users within one account. Typically, the multiple users are related individuals like family members. Each member will have his/her own account anonymous identifier. By storing each record with its associated identifier, an account system can easily retrieve data belonging to different users within one account. In a PHR program, supporting multiple family members to share one account has significant medical meanings. It benefits genetics study and family related disease diagnosis. By allowing a super user privilege be transferred among shared users, this invention also effectively solves the account inherent problem.

Another benefit for this invention is that it resolves the visibility problem of password duplications. Whether a password is stored in its encryption or not, a duplicated password will have a duplicated stored value. Because a login name is always unique, a relationship token that comprises a login name and a password can be unique. A stored anonymous login password identifier hashed from said token can be unique too. A password can be verified by testing a stored anonymous login password identifier with the hash result of a relationship token that comprises the password and its related login name.

In the end, it is worthy to point out that although the present invention has thus been described in detail with regard to the preferred embodiments, it should be apparent to those skilled in the art that various adaptations and modifications of the present invention may be accomplished without departing from the spirit and the scope of the invention. Accordingly, it is to be understood that the detailed description is not intended to limit the breadth of the present invention, which should be inferred only from the following claims and their appropriately construed legal equivalents.

1. A method for anonymously preserving a relationship among a finite set of values of a plurality of objects, comprising:
a. constructing a relationship token by comprising said finite set of values of said plurality of objects
b. providing hash means for generating a relationship identifier by hashing said relationship token so that said relationship identifier is substantially irreversible and its relationship with said relationship token is substantially injective
c. storing said relationship identifier in a storage media so that said relationship among said finite set of values of said plurality of objects is anonymously preserved
whereby said relationship among said finite set of values of said plurality of objects can be anonymously preserved without storing said finite set of values that might contain sensitive information.

2. The method of claim 1, further including a method for verifying whether an anonymously preserved relationship exists among a different set of values of said plurality of objects, comprising:
a. constructing a test relationship token that comprises said different set of values of said plurality of objects
b. hashing said test relationship token using said hash means to produce a test relationship identifier
c. matching a stored relationship identifier with said test relationship identifier by searching stored relationship identifiers
d. confirming a preserved relationship existing among said different set of values of said plurality of objects if a match is found.

3. The method of claim 1 wherein said relationship token comprises a value separator.

4. The method of claim 1, further including formatting a value of said finite set of values to a fixed length string and using said fixed length string to replace said value in constructing said relationship token.

5. The method of claim 1, further including encrypting a value of said finite set of values to get an encryption string and using said encryption string to replace said value in constructing said relationship token.

6. The method of claim 1 wherein adjacent said values in said relationship token belonging to different symbol sets.

7. The method of claim 1 wherein said finite set of values of a plurality of objects comprising a login name object value and a password object value.

8. A method for constructing an account anonymous identifier for an account in an account system by anonymously preserving a relationship among a finite set of values of a plurality of said account related objects, comprising
a. constructing a unique relationship token by comprising a finite set of values of a plurality of said account related objects
b. providing hash means for generating an account anonymous identifier by hashing said unique relationship token so that said account anonymous identifier is substantially irreversible and its relationship with said unique relationship token is substantially injective
c. storing said account anonymous identifier and its association with said account in said account system in a storage media so that said account system can identify an account by a given account anonymous identifier
whereby said account system is able to use said account anonymous identifier to identify said account without storing said relationship token that might contain sensitive information.

9. The method of claim 8 wherein said account anonymous identifier is unique within said account system.

10. The method of claim 8 wherein a value of said finite set of values of a plurality of said account related objects contains a piece of identity information of an owner of said account.

11. The method of claim 8 wherein said account anonymous identifier is generated at a client side.

12. The method of claim 8 wherein said account anonymous identifier is saved at a client side.

13. The method of claim 8 wherein said account anonymous identifier is a login name encryption of said account.

14. The method of claim 8, wherein said account anonymous identifier is an account ID of said account.

15. The method of claim 8 wherein a plurality of said account anonymous identifiers are constructed and stored for said account
whereby said account is able to match more identifiers to accommodate third parties that have different information to construct different account anonymous identifiers.

16. The method of claim 8, further comprising storage means for storing the associations of said account anonymous identifier with its related records within said account.

17. The method of claim 8, further including a method for boosting the security level of a stored account anonymous identifier by storing the hash result of said account anonymous identifier, comprising:
a. providing a hash means to hash said account anonymous identifier so that a new account anonymous identifier can be obtained
b. replacing said account anonymous identifier with said new account anonymous identifier in said storing process so that said new account anonymous identifier and its association with said account in said account system are stored, and said account system can identify an account by using a hash result that is generated by applying said hash means on a given account anonymous identifier
whereby said account system is able to use said new account anonymous identifier, an value cannot be constructed by a party that does not know said hash means, as a stored account anonymous identifier to identify an account, substantially increasing the security level of an account identification process.

18. The method of claim 8, further including a method for an third party to identify an account within said account system, comprising:
a. constructing a relationship token that comprises a finite set of values of a plurality of said account related objects from available data sources of said third party
b. providing hash means for generating an existing account anonymous identifier by hashing said relationship token
c. submitting said existing account anonymous identifier to said account system for identifying said account
d. searching stored account anonymous identifiers within said account system for an account identifier match using an identifier selected from the group consisting of said submitted existing account anonymous identifier and a new identifier that is generated by hashing said submitted existing account anonymous identifier
e. identifying an existing account as an account identified by said third party if a stored account anonymous identifier of said existing account matches with an identifier selected from the group consisting of said submitted existing account anonymous identifier and a new identifier generated by hashing said submitted existing account anonymous identifier.
whereby said third party is able use its own data source and knowledge of the relationship among said account related objects to independently construct an effective existing account anonymous identifier to identify an existing account without prior communication with said account system.

19. The method of claim 10, further including a method for an account owner to recover his/her account ownership of an existing account in said account system, comprising:
a. constructing a relationship token that comprises a finite set of values of a plurality of said account related objects using said owner identity information
b. submitting said relationship token together with related identity documents to said account system
c. verifying whether said submitted relationship token is truly constructed with the identity information from said submitted documents
d. hashing said submitted relationship token to produce an existing account anonymous identifier
e. searching said existing account anonymous identifier among stored account anonymous identifiers for a match
f. granting the account ownership of an existing account to said account owner if said relationship token is constructed with the identity information from said submitted documents and a stored account anonymous identifier associated with said existing account matches with said existing account anonymous identifier.

20. The method of claim 8, further comprising a method for supporting multiple users to share said account by storing the associations of a said account anonymous identifier with its related records, comprising:
a. using a piece of identity information of a said user to construct a unique relationship token for a said user
b. constructing a unique relationship token for each said multiple users
c. hashing each said unique relationship token by said providing hash means for generating an account anonymous identifier for each said multiple users
d. storing each said account anonymous identifier, its association with said account in said account system in a storage media so that said account system can identify an account by a given account anonymous identifier
e. storing the associations of a said account anonymous identifier with its related records so that said account system can classify a record within said account by a given account anonymous identifier.

21. The method of claim 8 wherein said unique relationship token is a login name of said account.
